(19) United States
(12) Patent Application Publication
(10) Pub. No.: US 2009/0157630 A1
(43) Pub. Date: Jun. 18, 2009

(54) Method of extracting data and recommending and generating visual displays

(76) Inventor: Max Yuan, Mesa, AZ (US)

Correspondence Address: ETHERTON LAW GROUP, LLC, 5555 E. VAN BUREN STREET, SUITE 100, PHOENIX, AZ, 85008, US

(21) Appl. No.: 12/290,061

(22) Filed: Oct. 27, 2008

Related U.S. Application Data
(60) Provisional application No. 61/000,618, filed on Oct. 26, 2007.

(51) Int. Cl. G06F 17/30; G06F 3/048; G06Q 30/00

(52) U.S. Cl. 707/3; 715/810; 707/1; 705/1; 707/E17.001; 707/E17.108

(57) ABSTRACT

A method of recommending and generating visual displays of data by executing a visualization tool that operates as part of a comprehensive Web-based computing platform can be accessed via a website, customizable interface, email, telephone, or other remote communication device. The visualization tool operates by accessing the data source and then executing an analysis engine to parse numerical and other forms of data. If necessary, a data mining tool can also be used to download data and a semantic template editor can be used to generate a template for parsing any type of data. The data and data format are identified, and the visualization tool executes a recommendation engine that considers the data and data format and recommends suitable visual display styles and visual display options and recommends additional compatible algorithms. Additionally, users can provide their own compatible algorithms for data processing. The user then selects one or more display styles or graphs and display options. If there are compatible algorithms, the user can select a pre-programmed algorithm or a user-generated algorithm as well. The computation engine executes the algorithms, performs calculations associated with the chosen visual display style, and outputs a file according to a given API protocol. A presentation program uses the output file to generate a visual display. Finally, the visualization tool delivers the display to the user, saves the display, and/or publishes the display.

### CROSS-REFERENCE TO RELATED APPLICATIONS

This application claims the benefit of U.S. Provisional Application No. 61/000,618 filed Oct. 26, 2007.

### FIELD OF THE INVENTION

This invention relates to a method of extracting data and recommending and generating visual displays of data on a computer system. In particular, this invention relates to executing a visualization tool accessible on a Web-based computing platform.

### BACKGROUND TO THE INVENTION

Computing tools include tools that perform simple or complex computations as well as tools that display data and computations in charts, graphs, and other visual forms for an end user. When reviewing a large data source, it can be intimidating, overwhelming, and seemingly impossible to distill the data into subsets and categories for further analysis. For example, a review of the United States Patent and Trademark Office online database of issued patents contains a large volume of data, including classifications, priority dates, filing dates, issue dates, examiners, art units, cited prior art, figures, inventors, and many more categories. Distilling and organizing that data to find trends can be daunting. Moreover, it may not be readily discernible the many ways one could visualize the results. A tool that can access the database, analyze the database for trends based on simple or complex commands, recommend visualization options and convert the data to a visual presentation would be valuable and useful to both casual and sophisticated users.

Current computing tools for visualizing data include hardware tools, software tools, and World Wide Web-based tools. For example, graphing calculators, one type of a visualization tool, are widely used hardware tools for computations. Graphing calculators, however, have a primitive and small display, are highly specialized, lack the ability to expand, and require a user to individually input data. Moreover, graphing calculators require a battery and can be expensive.

Examples of software computing and visualization tools include programs such as Matlab®, Maple™, Mathematical, spreadsheet programs such as Excel®, and PowerPoint®. Typically, however, these software tools involve a complex interface, require expensive hardware, have poor collaboration, have limited customization capability are subject to restrictive licensing with high licensing fees, involve multiple editions, and require maintenance and upgrade costs. Furthermore, these software tools lack the ability to access, distill, analyze, and organize data and recommend appropriate visualization options to a user.

Due to its wide use in the modern world, the World Wide Web (commonly shortened to “Web”) has become the basis of modern technology and a desirable platform for computing tools. Currently available Web-based computing tools, however, have limited features and poor navigation. Additionally, current Web-based computing tools have confusing interfaces and are not scalable or reusable. Finally, the current tools lack a user community, have no collaboration features, and lack the ability to distill, analyze and organize varied data for visualization.

Recent trends in Web development revolve around Web 2.0, which refers to the transition of websites from isolated information sites to interlinked computing platforms that act like software to the user. In general, Web 2.0 surpasses the original Web with its information storage, creation, and dissemination capabilities. The infrastructure of Web 2.0 includes server-software, content-syndication, messaging-protocols, standards-based browsers with plug-ins and extensions, and various client-applications. Additionally, recent trends include cloud computing in which IT-related capabilities are provided as a service, allowing users to access technology-enabled services from the internet without knowledge of, expertise with, or control over the technology infrastructure that supports them. Similarly ubiquitous computing has become prevalent; information processing has been integrated into everyday objects and activities such that a human engages many computational devices and systems simultaneously in the course of their ordinary activities possibly without even being aware he is doing so. Another trend, the Semantic Web, is an evolving extension of the World Wide Web in which the semantics of information and services on the Web is defined, making it possible for the Web to understand and satisfy the requests of people and machines to use the Web content.

Web 2.0 supports technologies such as weblogs, social bookmarking, wikis, podcasts, RSS feeds, social software, web application programming interfaces (APIs), and online Web services. Web 2.0 websites exhibit characteristics such as delivering and allowing users to use applications entirely through a Web browser; allowing users to own data on a site and exercise control of the data; having users add value to an application as the user uses it; providing an interactive and rich interface based on Ajax (short for “Asynchronous JavaScript and XML”) or similar frameworks; and providing some social-networking aspects.

With Web 2.0, Web-based applications and desktops have evolved. Through Ajax, Adobe A Flex®, Microsoft® Silverlight™, or similar rich Internet application frameworks developers have been able to provide richer user experiences through websites that mimic personal computer applications such as word-processing and spreadsheet applications. Additionally, users can now use several browser-based operating systems or online desktops, which function as application platforms rather than as operating systems per se. While these services appear to the user as a desktop operating system, they are capable of running within any modern browser.

In addition to rich Internet application techniques frameworks, Web 2.0 websites typically also include semantically valid XHTML and HTML markups; microformats enriching pages with additional semantics; folksonomies, such as tags or tagclouds; cascading style sheets; and REST and/or XML- and/or JSON-based APIs. Web 2.0 websites also include syndication, aggregation and notification of data in RSS or Atom feeds; client- and server-side mashups, which merge content from different sources; weblog publishing tools; wiki or forum software to support user generated content; openID for transferable user identity; and use of open source software. It would be desirable to create a Web-based computing platform with rich interactive features that includes computing and visualization tools.

Accordingly, it is an object of this invention to create a dynamic Web-based computing platform that involves Web services and Web applications that are easy to navigate and understand, are scalable and reusable, and contain rich features. It is particularly an object of this invention to provide a visualization computing tool where users can access the tool and data from any computer, can collaborate with others, can publish results, can solicit assistance from a worldwide audience, and can print or email their visual displays and computations. It is an object of this invention to enable visualization developers to design presentation programs without having to worry about data mining, data processing and compatibility issues. It is a further object of this invention to provide a visualization tool capable of accessing various forms of live and static data, analyzing the data, organizing the data, and presenting a user with various visualization options for displaying the data.

### SUMMARY OF THE INVENTION

This invention involves a method of extracting data and recommending and generating visual displays of data by executing a visualization tool that operates as part of a comprehensive Web-based computing platform. The computing platform and visualization tool can be accessed via a website, customizable interface, email, telephone, or other remote communication device. The visualization tool operates by accessing the data source and executing an analysis engine to parse and extract numerical and other forms of data. The visualization tool also executes a recommendation engine that considers the extracted data and recommends suitable visual display styles and visual display options and recommends additional compatible algorithms. Additionally, users can provide their own compatible algorithms for data processing. The user selects one or more display styles or graphs and display options. Additionally, if there are compatible algorithms, the user can select a pre-programmed algorithm or a user-generated algorithm as well. Additionally, the visualization tool transforms the data with a computation engine according to the user's selections and through execution of any selected algorithms and outputs a file according to a given protocol. The output file can then be accessed by third-party presentation programs that use the same given protocol to generate a visual display. Finally, the visualization tool can deliver the visual display to the user and can optionally save or publish the display as well.

The data accessed by the visualization tool can be live or static data, and there can be multiple data sources. Additionally, the visualization tool can be applied to user-supplied data, data stored in a data repository on the computing platform, data stored elsewhere on the internet, or mined data. The visualization tool can access and execute a data mining tool and a semantic template editor that are part of the Web-based computing platform to download, parse and extract data from single or multiple pages of numerical or other forms of data. Additionally, the visualization tool can access a conversion tool to convert, for example between equations and data or convert between different API protocols, and can access other features of the Web-based computing platform such as a library of equations to enhance the visualization tool's features. The visualization tool through the computing platform also can be incorporated into user-created applications on the computing platform and can be available for a community of users for sharing and discussing their results and research.

### BRIEF DESCRIPTION OF THE DRAWINGS

FIG. 1a is a schematic of services and tools offered by the Web-based computing platform.

FIG. 1b is a diagram of the distributed computing model preferably used by the Web-based computing platform.

FIG. 2 is a schematic of the multiple interfaces for the Web-based computing platform.

FIG. 3 is a schematic of the overall operation of the visualization tool.

FIG. 4a is a schematic of the data repository of the visualization tool of the Web-based computing platform.

FIG. 4b is a schematic of the data mining tool of the Web-based computing platform.

FIG. 4c is a schematic of the analysis engine of the Web-based computing platform.

FIG. 4d is a schematic of the markup language parser of the analysis engine of the Web-based computing platform.

FIG. 4e is an illustration of the Web-based interface and template markup of the semantic template editor of the Web-based computing platform.

FIG. 5a is a schematic of the recommendation engine of the Web-based computing platform.

FIG. 5b is a diagram of the ranking and sorting options for the recommendation engine of the Web-based computing platform.

FIG. 6a is a schematic of the transformation interfaces of the Web-based computing platform.

FIG. 6b is an example of the output of the computations engine according to the visualization API protocol and the associated generated display.

FIG. 6c is another example of the output of the computation engine according to the visualization API protocol and the associated generated display.

FIG. 7 is an example of the visualization API protocol for the visualization tool for the Web-based computing platform.

FIG. 8a is a schematic of an embodiment of the visualization tool for displaying equations as flowcharts.

FIG. 8b is a schematic of an embodiment of the visualization tool where multiple live data sources are compared.

FIG. 8c is a schematic of an embodiment of the visualization tool for generating equations and data where the input data is a graph.

FIG. 9 is a schematic of the data and equation generator tool of the Web-based computing platform.

FIG. 10 is an example of an equation relationship map that is part of the library of equations of the Web-based computing platform.

FIG. 11 is a schematic of a point-based payment method.

### DETAILED DESCRIPTION OF THE INVENTION

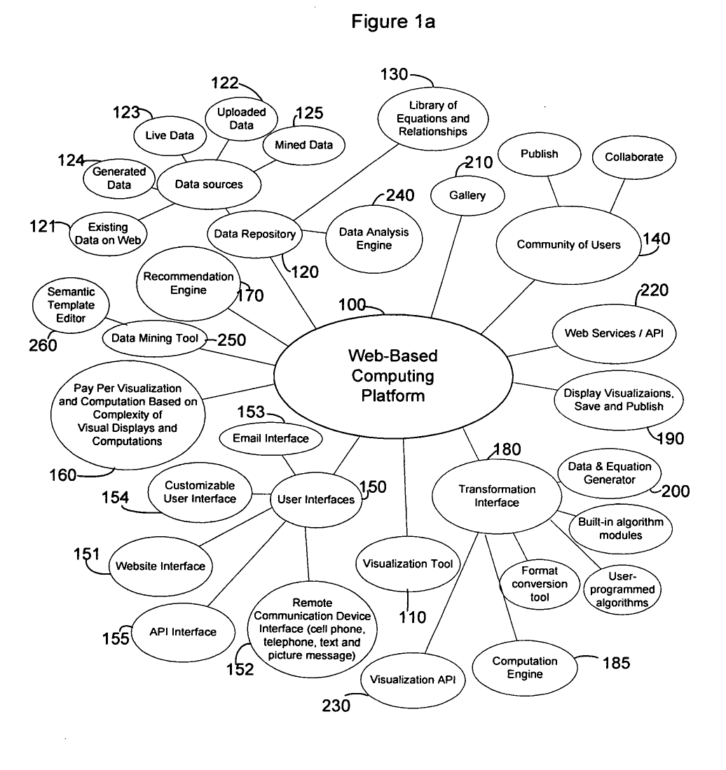

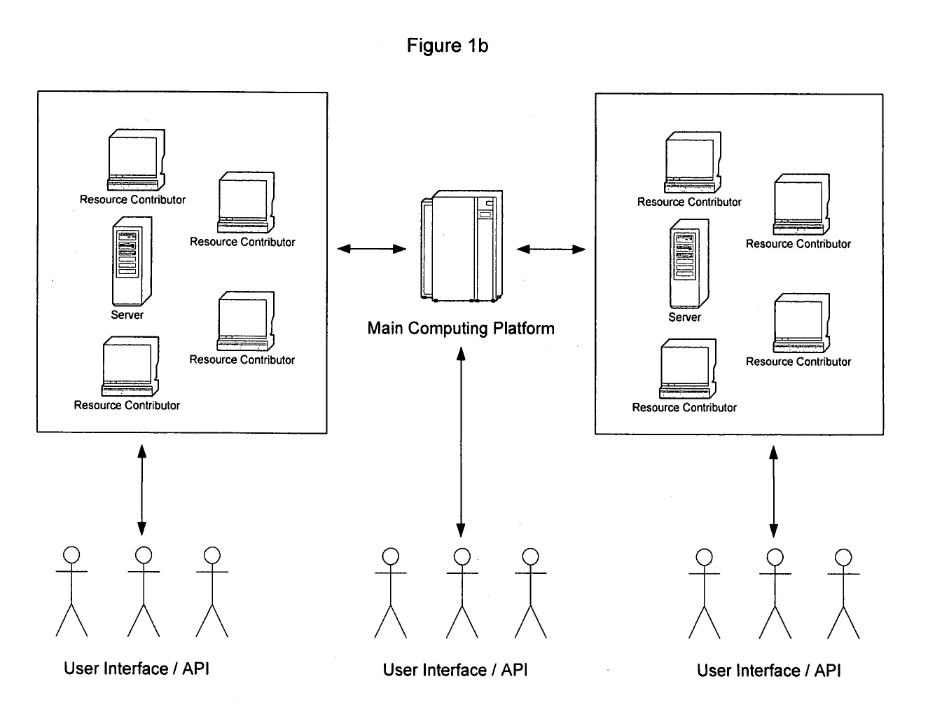

FIG. 1a illustrates the overall features of the Web-based computing platform 100 that includes and supports a visualization tool 110. As shown, the Web-based computing platform includes the visualization tool 110, a data repository 120, a library of equations and relationships 130; a community of users 140; multiple user interfaces 150; and a payment system 160. The Web-based computing platform 100 also includes a recommendation engine 170, transformation interfaces 180, abilities to display visualizations 190, a data and equation generator 200, a gallery 210, Web services 220, and a data mining tool 250. In general, the computing platform 100 provides the ability to create, import, export, tag, share, and store data and visualizations and associated programs and research; access to a community for publishing visualizations and collaborate; and a point-based payment method related to the complexity of the visualizations and associated computations. The visualization tool 110 and overall computing platform 100 can be accessed through a customizable user interface 154, a website interface 151, email interface 153, an application programming interface 155, or through other remote communication devices and methods 152 such as mobile devices, telephones, and text messaging. The visualization tool 110 can display visualizations 190 and can access the data repository 120, the recommendation engine 170, the transformation interfaces 180, the data and equation generator 200, the gallery 210, the community 140, and the library of equations and relationships 130 of the computing platform 100.

In general, the computing platform 100 and visualization tool 110 can be accessed by any user from any computer or other communication device having access to the World Wide Web. No other special software or hardware is needed on the user's local computer or communication device. The functions performed by the computing platform are preferably done on the server-side so that code execution on the end user's computer is not necessary. Large calculations are handled by multiple computers for faster results. The platform provides an application programming interface (API) that allows users to utilize and implement features the computing platform provides for their own applications, websites or Web services.

FIG. 1b illustrates the distributed computing system preferably used by the Web-based computing platform, which allows the Web-based computing platform features and tools to operate in a decentralized environment. As illustrated in FIG. 1b, a user can contribute his computer resources to the distributed computing network by installing an application on his computer. This is similar to the SETI@home scientific experiment, which uses Internet-connected computers that each participate in the search for extraterrestrial intelligence by running a free program that downloads and analyzes radio telescope data during the computer's typically idle-times. Another example of the Web-based computing platform and the distributed computing model includes businesses that want to keep their data private but still wish to use a feature or tool provided by the Web-based computing platform. For example, a private business can use the Web-based computing platform technology on its own server to protect its data but still benefit from the features and tools. It will be understood by those skilled in the art, however, that the visualization tool and features described herein can be used on any processor-based system such as a personal computer or other system including a central processing unit, a random access memory module, a read-only memory module, storage, a database, one or more input/output devices, and an interface.

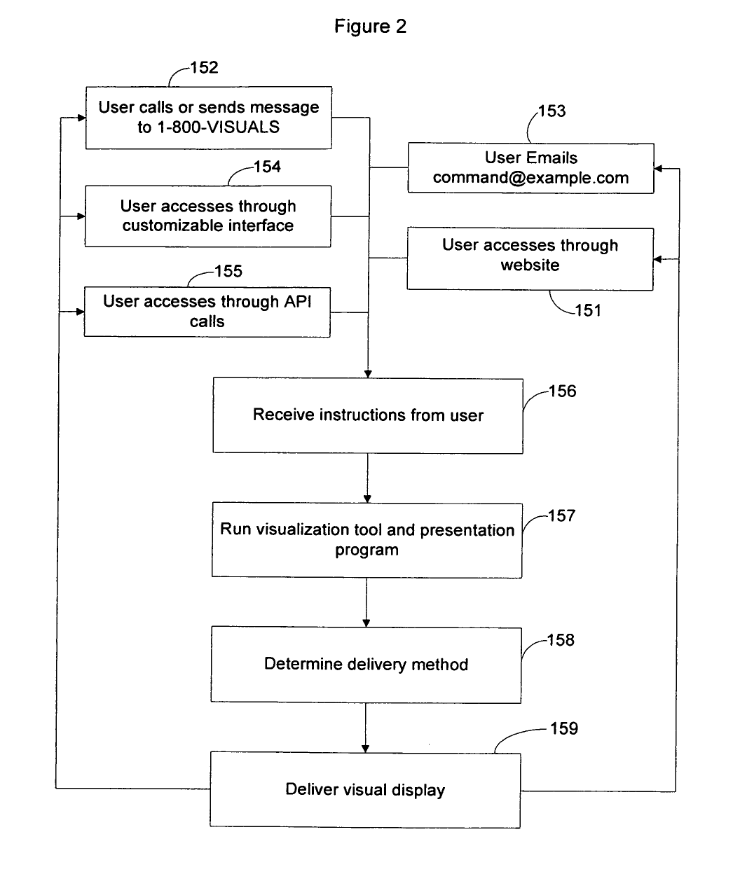

FIG. 2 illustrates how a user can access the computing platform through one of several user interfaces 150. The Web-based computing platform can be accessed through a website interface 151, email interface 153, or an application programming interface 155. For example www.example.com may be the website interface 151, which may have one or more email addresses associated with it. Accordingly, the email address to send a request, for example, might be command@example.com. Additionally, the platform can have a telephone number associated with it, such as 1-800-visuals, to facilitate an interface with other remote communication devices 152 such as telephones, mobile phones, or text messaging services. Any of the features of the Web-based computing platform can be accessed in this manner. For example, a user inputs instructions through one of the multiple interfaces 150 to the computing platform 100 and visualization tool 110. The input instruction is input either through an entry on a Web page, for example a browser's search box or in the URL of the website, such as http://www.example.com/graph(3x+6,x,0,10), a Web service message exchange via an application programming interface, through an email, either in the body, subject line or attachment, or through telephone entry by calling the platform's designated telephone number. Upon receiving the input instruction 156 to use the visualization tool 110, the Web-based computing platform accesses and executes 157 the visualization tool 110. After generating a visual display using the visualization tool and a presentation program, the delivery method is determined 158 and the visual display is delivered to the user 159. The delivery method can also be determined before executing the visualization tool or at any time during the execution of the visualization tool. For example, the visual display may appear on the website or it may be sent to the user through email or picture-message (MMS). The user can control the delivery method and the level of detail shown. In order to associate a user with an account, the user's email address, phone numbers, or an identification code can be associated with the visual display request.

If a user contacts the computing platform via email, the website may record the email address of the user for billing purposes and optionally for a usage log assigned to each user. For example, when the visualization tool and a presentation program generate a visual display, the display can be delivered to the user via an email and it can also be stored in the data repository of the computing platform. Similarly, if a user contacts the Web-based computing platform via telephone or text message, the computing platform records the incoming phone number and uses voice recognition to record the input. The visualization tool and the presentation program generate the display and then the result or display can be saved as a static or animated file and delivered to the user via a text or picture message. Finally, if the user accesses the visualization tool via the website directly, then the result or visual display can be displayed on the user's monitor or display screen. Additional alternatives include emailing the request and instructions and receiving a picture message in response or telephoning the request and instructions and receiving an email in response. Any combination of input methods and output delivery methods can be used.

When using the computing platform overall and, in particular, when using the visualization tool, a user can register and be assigned a unique username or identification code that he inputs for billing purposes, for recording or logging purposes, for storing and later publishing or exporting data and visual displays, and for designating preferences with respect to delivery methods and other options. Additionally, each user can have a personalized view of the computing platform's website that reflects his particular use of the system. For example, a user's frequently-used equations or functions can be prominently listed or displayed. Likewise, a user's community connections and collaborative efforts can be displayed, highlighted, linked or similarly noted and personalized. Additionally, the website can provide additional social networking features such as displaying a list of associates, forming or joining an interest group, and searching for people with similar interests.

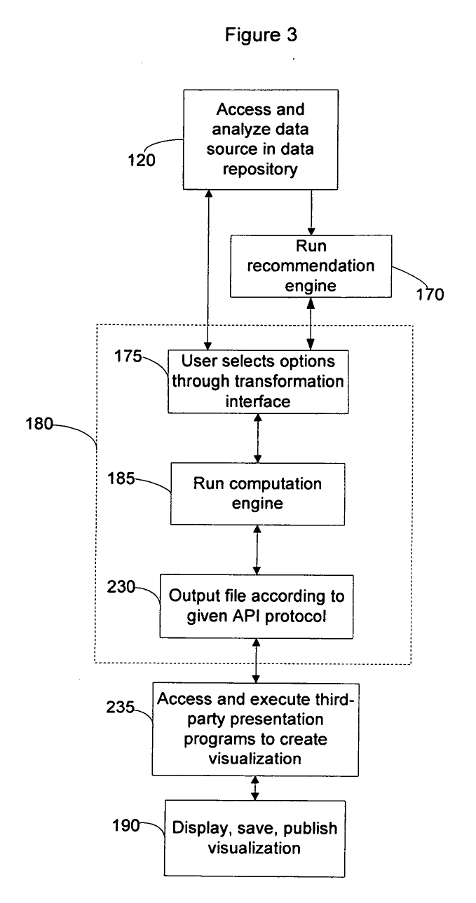

FIG. 3 illustrates the overall operation of the visualization tool 110 of the computing platform 100. The visualization tool accesses and analyzes the user-selected data source through the computing platform's data repository 120. The visualization tool 110 accesses and executes the recommendation engine 170 to review and suggest suitable graphs and visualization options given the user-selected data source. The visualization tool 110 accesses and executes the transformation interfaces 180 to query the user's visualization preferences and select a user-generated or built-in algorithm for further transforming the data 175, to execute the chosen algorithms and selections within the computation engine 185, and to output a file according to a given API protocol 230. The output file includes a text file and is the data or code output by an application programming interface protocol. The visualization tool 110 accesses and executes a presentation program 235 compatible with the given API protocol for generating a visual display 235. The visualization tool displays, saves, or publishes the visualization or visual display 190. The process also can be reversed. From a display of a visualization 190, data can be extracted and generated with the computation engine 185. The generated data 124 can be stored in the data repository 120.

Accessing user-selected data sources with the data repository 120 of the visualization tool 110 involves accessing several data sources and features. The data repository 120 includes, for example, existing stored data on the World Wide Web 121 or in the data repository 120, uploaded or imported data 122, live data 123, generated data 124, mined data 125, and any other form of data that can be delivered to the Web-based computing platform. For example, data can be generated from equations, either user-defined equations or equations accessed through the computing platform or from visual displays. A user can also import live or static data using the computing platform. For example, a user may want to import data from files such as excel, word, pdf, txt, gif, xml, png, or zip files. Data can also be imported, for example, from Matlab® programs. Users can collect live or static data with common devices such as cell phones via SMS or with special hardware such as temperature sensors or blood pressure monitors. Users can also tag and give meanings to pure numbers and data. Additionally, users can access the data repository of the computer platform, link to other external databases, and communicate with other Web services. Users also can cross-reference and perform calculations with multiple data sources, for example stock market index verses interest rates. Data can also be mined with a data mining feature from external sources.

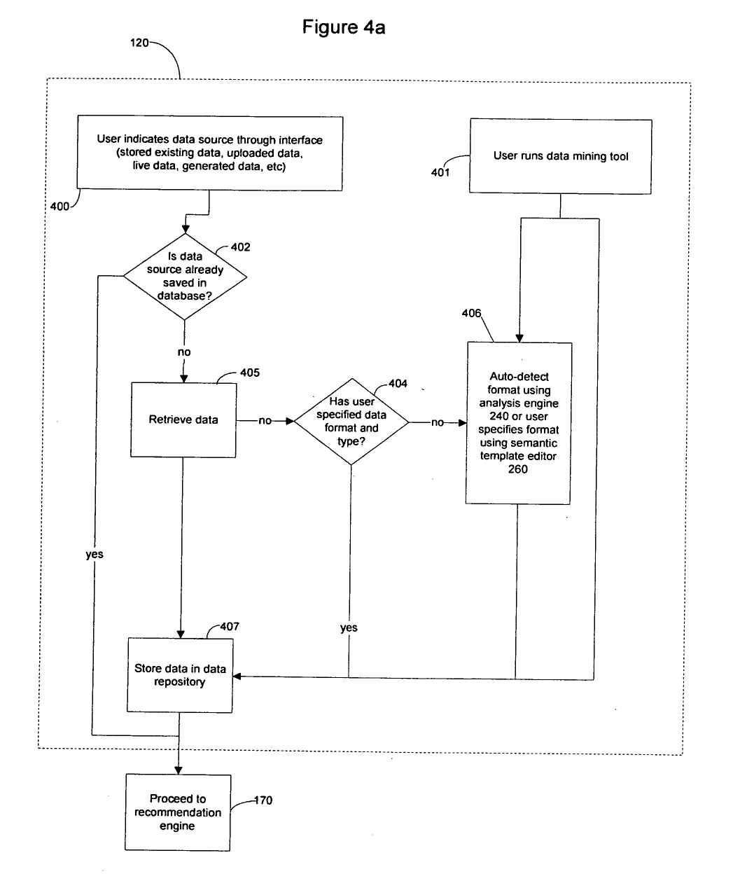

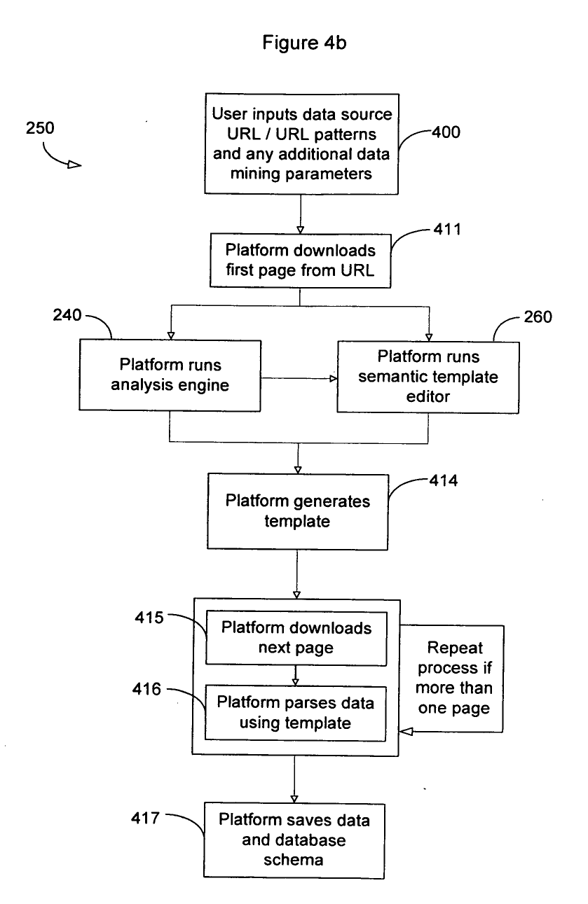

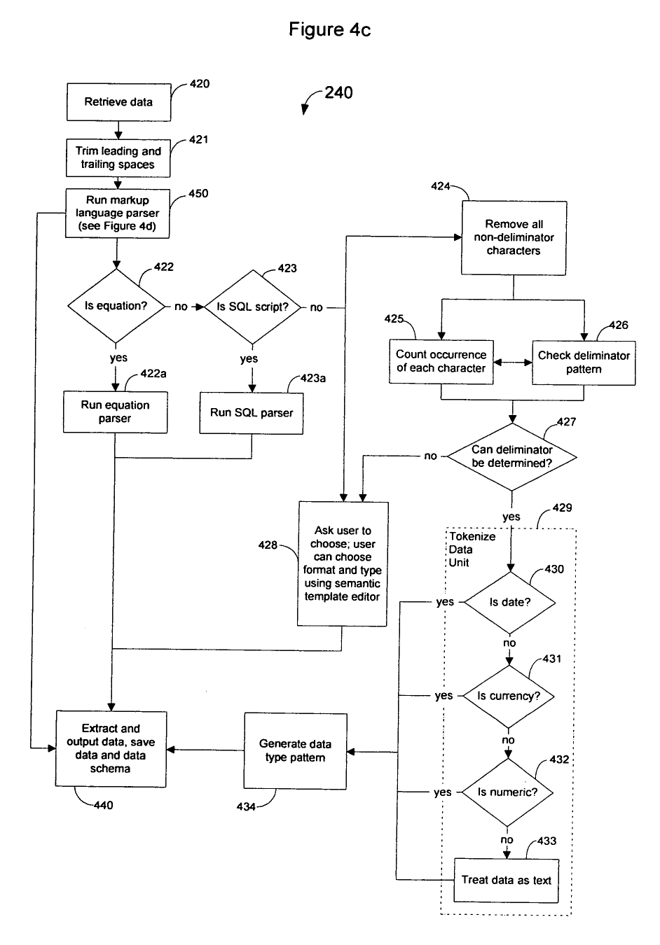

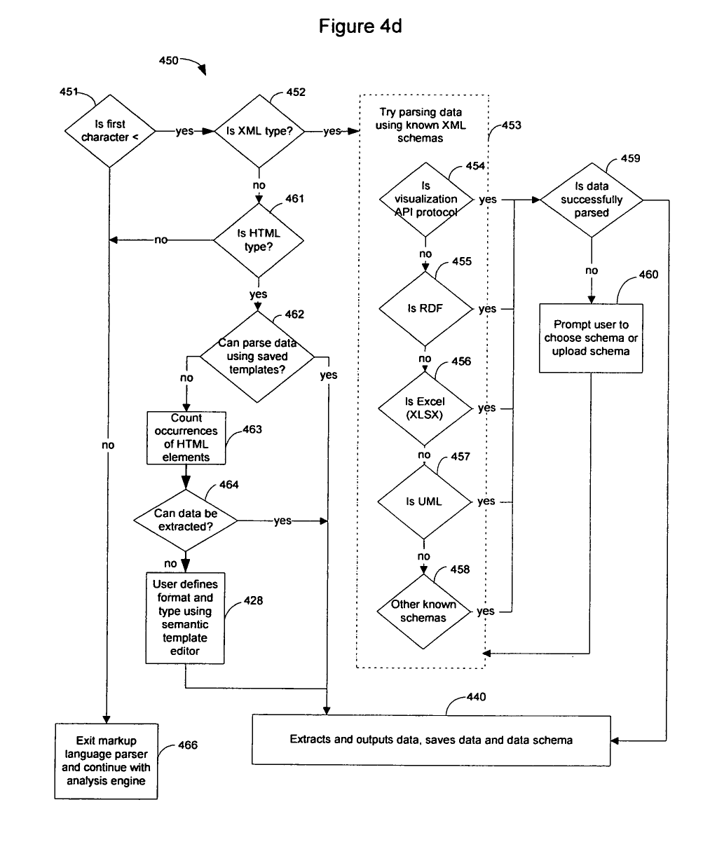

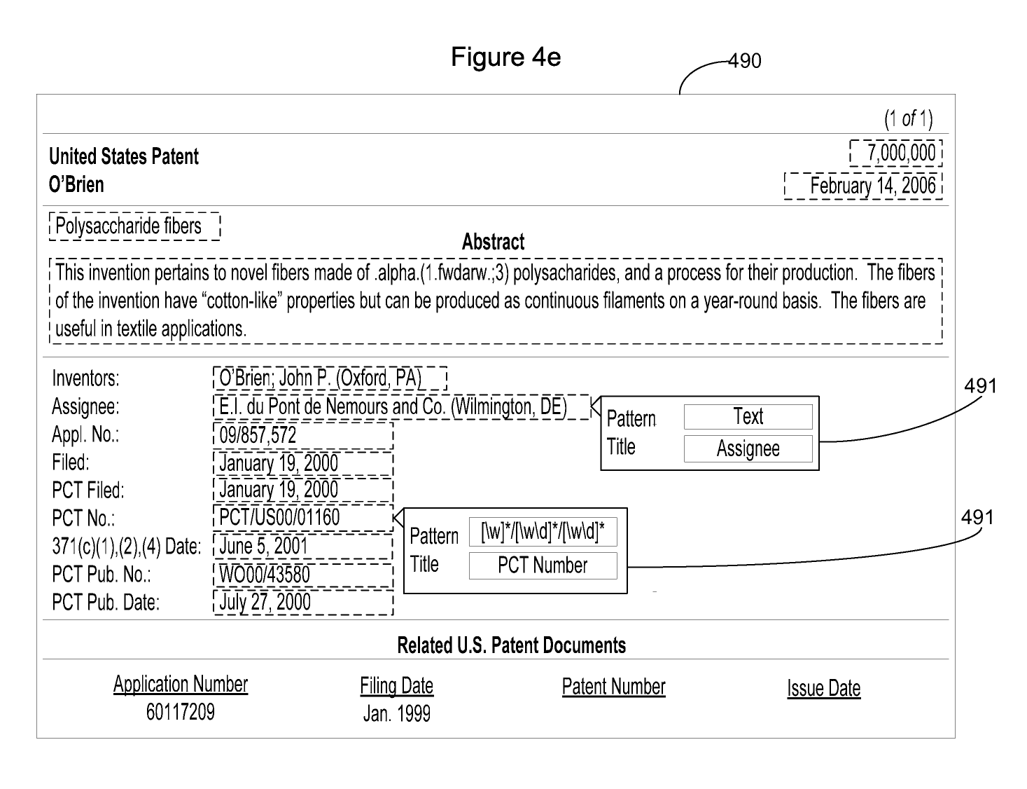

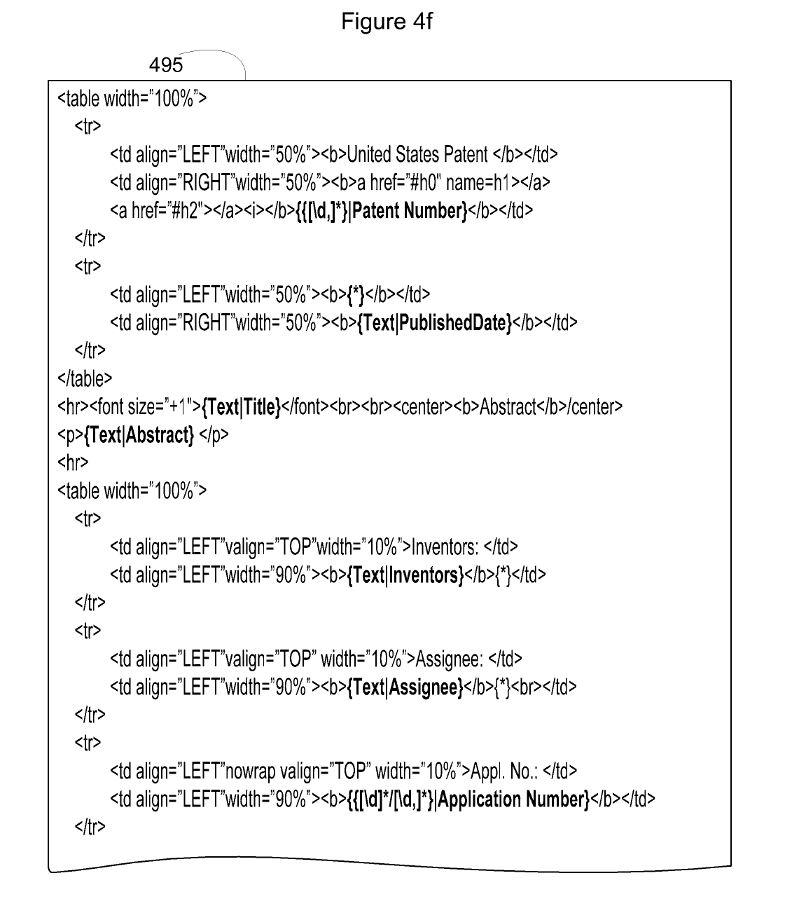

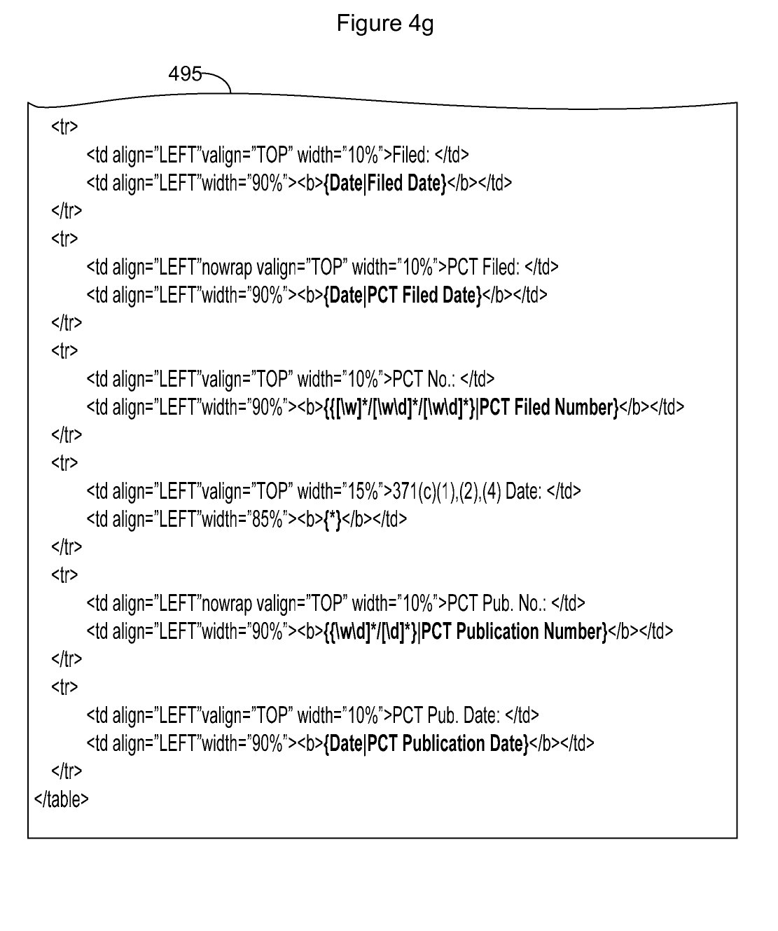

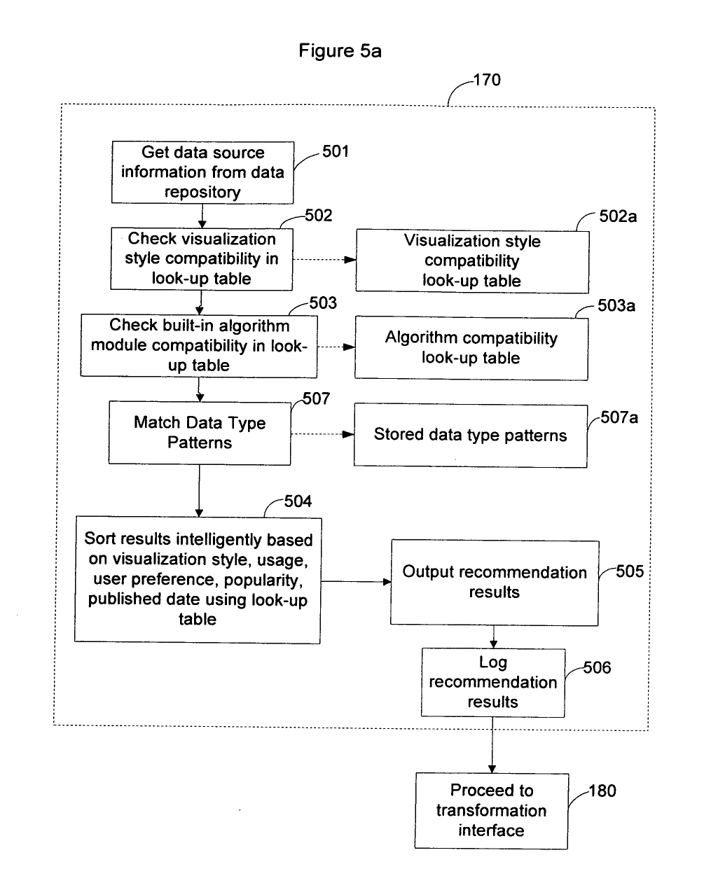

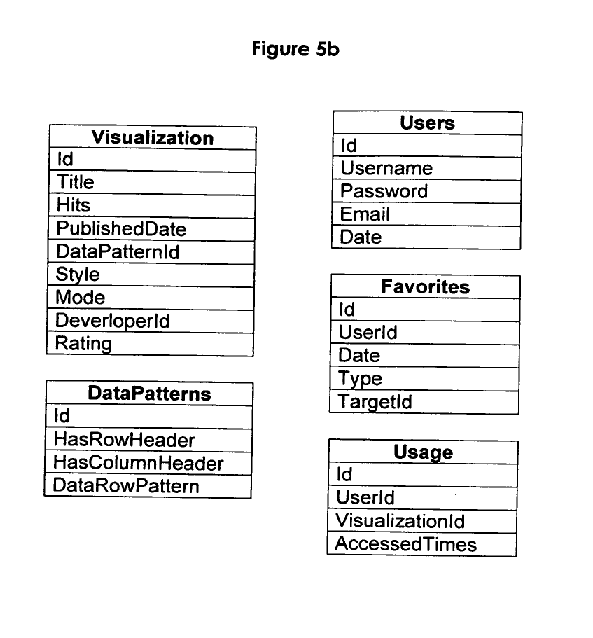

FIG. 4a illustrates the data repository 120 features of the Web-based computing platform. The data repository can store and access any type and format of data. In general, data includes data, data information and data format, and data format includes any information about the data structure including data schema and data patterns. Additionally, data can be numerical, string, or generic, and can be tabular, vector, relational, work flow, hierarchical, animated, or streamed. When using the visualization tool 110, a user enters or selects 400 a data source or chooses to run 401 the data mining tool 250. The data source can be data already stored in the data repository or it can be uploaded data, live data, generated data, data stored elsewhere, or other forms of data. If the user entered, selected, or provided a data source 400, then the data source is reviewed 402 to see if it is already stored in the data repository 120 or elsewhere. If it is stored in the data repository 120, then the visualization tool can proceed to the recommendation engine 170. The recommendation engine 170 will be described in detail below with respect to FIG. 5. The data can be stored temporarily or permanently in the data repository 120 if desired. If the data source is something other than already existing stored data, the platform retrieves the data 405, and then the user is asked to either specify a data format 404 or to choose to auto-detect the format 406 using the analysis engine 240, which is described in detail below with respect to FIG. 4c. If the user chooses to specify the format, then the data can be stored 407 in the data repository 120 accordingly. If the user chooses to run the analysis engine 240, then the format will be determined and the data will be stored 407 in the data repository 120 accordingly. Once the data is stored in the data repository 120, the visualization tool 110 can proceed to the recommendation engine 170. Finally, if the user generated data 401 with the data mining tool 250, the data will be stored 407 in the data repository 120 and if needed, the user can run the analysis engine 240 to further determine the data format. Details of the data mining tool 250 will be explained below with respect to FIG. 4b.

FIG. 4b illustrates the data mining tool 250. Through the computing platform's user interface 150, the user inputs, selects, or provides 400 one or more resources, pages, URLs, documents or other data source from which the computer platform should mine data. For example, if the user wants to mine data from U.S. Pat. No. 7,000,000 as available on the USPTO website, the user inputs the URL http://patft.uspto.gov/netacgi/nph-Parser?Sect1=PTO1&Sect2=HITOFF&d=PALL&p=1&u=%2Fnetahtml%2FPTO%2Fsrchnum.htm&r=1&f=G&I=50&s1=7000000.PN.&OS=PN/7000000&RS=PN/7000000. Alternatively, if the user wants to mine data from U.S. Pat. Nos. 7,000,000 through 7,000,005, the user inputs the URL pattern http://patft.uspto.gov/netacgi/nph-Parser?Sect1=PTO1&Sect2=HITOFF&d=PALL&p=1&u=2Fnetahtml%2FPTO%2Fsrchnum.htm&r=1&f=G&I=50&s1={7000000-7000005}.PN.&OS=PN/{7000000-700005}&RS=PN/{7000000-7000005}. The URL pattern may also be in regular expression or wild card format. Through the user interface 150, the user also can set additional parameters such as the number of data mining agents and the data mining schedule. Additionally, through the user interface 150 the user can monitor the speed and cost of the data mining job, can save selections as a data mining job for immediate or delayed execution, and can combine multiple saved data mining jobs as a batch data mining job. After the data mining parameters are set, the data mining tool checks the server's robots.txt file for permissions, if allowed it then downloads the first page 411. If the page contains numerical data, the data mining tool 250 accesses and runs the analysis engine 240 and generates a template for parsing the data 414. If the page contains data in the form of text, the data mining tool accesses and runs the semantic template editor 260 and generates a template for parsing the text data 414. The user can choose whether to run either the analysis engine 240 or run the semantic template editor 260, or the data mining tool first accesses and executes the analysis engine 240 and second accesses the semantic template editor 260 only if the analysis engine 240 was not appropriate. After a template has been generated, the next page of data is downloaded 415 and data is parsed according to the previously generated template 416. This then repeats for each additional page of data. The data and the database schema are then saved 417 in the data repository 120.

FIG. 4c illustrates the analysis engine 240 that is used by both the data mining tool 250 and the data repository 120. The analysis engine 240 begins by retrieving 420 the data if it has not already been retrieved. From the data, it next trims the leading and trailing spaces 421 and runs the markup language parser 450, which will be discussed in detail with respect to FIG. 4d. If the markup language parser 450 could not extract and output the data, then the analysis engine determines if the data is an equation 422. If it is an equation, the analysis engine runs an equation parser 422a to extract and output the data and saves the data and data schema 440. If data was not an equation, the analysis engine determines if the data is SQL script 423. If it is SQL script, then the analysis engine runs an SQL parser 423a to extract and output the data and saves the data and data schema 440. If data is not an equation or SQL script, the user can choose a format and type of data 428 or the analysis engine can tag data type for the user by first removing all non-deliminator characters 424 such as commas, quotations, apostrophes, semi-colons, tabs, returns, and spaces. Next, the occurrence of each character is counted 425 and the deliminator pattern is checked 426. If a deliminator cannot be determined, then the user again can choose a format and type 428. If a deliminator can be determined 427, then the analysis engine tokenizes the data unit 249. For example if the pattern is three commas and a return, then the data format is CSV and the data can be tokenized 429 to determine whether it is date data 430, currency data 431, numeric data 432, or other data types. If it cannot be parsed, then the data will be treated as text 433. The analysis can then generate the data type pattern 434 for use in the recommendation engine and extract and output the data and save the data and data schema 440. If the user elects to or must choose a format and type of data, then the user can use the semantic template editor 260 to extract and output data 440. The semantic template editor is described in detail with respect to FIG. 4e.

In FIG. 4d, the markup language parser 450 checks to see if the first character is a greater-than symbol 451. If it is not, then the analysis engine exits the markup language parser 466. If it is, then the markup language checks to determine if the data is XML type and HTML type. If it is neither type, then again the analysis engine exits the markup language parser 466. If the data is XML type, then the markup language parser tries to parse the data using known XML schemas 453, such as visualization protocol schema 454, RDF (Resource Description Framework) 455, Excel 456, UML (Unified Modeling Language) 457 or any other known schemas 458. If the data is not successfully parsed, then the markup language parser prompts the user to choose a schema or upload a schema 460 before continuing with parsing 453. Once the data is successfully parsed 459, then the analysis engine can extract and output the data and save the data and data schema 440. If the data is HTML type, then the markup language parser tries to parse the data using any saved templates 462 such as templates saved by the semantic template editor. If it can use a saved template, then the analysis engine can extract and output the data and save the data and data schema. If there are no appropriate saved templates, then the markup language parser counts the number of HTML elements 463 such as table tags, list tags, or header tags. It then counts the number of child elements to determine whether data is contained or can then be extracted. The markup language parser may prompt the user if needed. The analysis engine will extract the data and save the data and data schema 440. If the data cannot be extracted after counting the occurrences of HTML elements, then the user can define the format and type using the semantic template editor 428 and then the data can be extracted and saved 440.

FIG. 4e illustrates the semantic template editor 260 used by the data mining tool 250 for data that is not numerical. If the analysis engine 240 determines that the data is not numerical, the semantic template editor 260 is accessed. The semantic template editor 260 is an HTML like editor where the user can either use a graphical WYSIWYG (What You See Is What You Get) interface 490 or alter the template markup manually 495. To use the graphical interface 490, the first page of the data is displayed and the user highlights the text to use as a data field. Additional information fields may be used to assign meaning to content. For example, in FIG. 4e, the user has highlighted the Assignee's name and the PCT Number in the graphical interface 490. Upon highlighting the text, a dialog box 491 appears for the user to insert a pattern and title for the data field. For example, the user has selected the pattern Text and the title Assignee for the highlighted Assignee's name. Additionally, the user has selected the pattern [\w]*/\[w\d]*/[w/d]* and the title PCT Number for the highlighted PCT Number. The section of template markup corresponding to the highlighted text is then replaced with a placeholder so that the whole page becomes a template for the chosen data field. After generating the template, the data can be mined from each page accordingly. If a user does not wish to use the graphical interface, the user can manually replace the template markup where appropriate with a placeholder. For example as shown in the template markup 495 shown in FIG. 4e, the user has manually replaced the title section of the front page of a U.S. patent with the placeholder {Text/Title} and the abstract section with the placeholder {Text/Abstract}. Additionally, the user has manually inserted placeholders for the Inventors, the Assignee, the Application Number, the Filed Date, the PCT Number, the PCT Publication Number, and the PCT Publication Date.

FIG. 5a illustrates the recommendation engine 170 of the visualization tool 110. The computing platform 100 accesses and executes the recommendation engine 170 to determine what types of visual displays or presentations would be appropriate or suitable given the data. The analysis engine retrieves 501 data information including data and any data schema from the data repository 120 and next compares 502 it to a look-up table of visualization styles 502a. Following is an example of the visualization styles look-up table 502a:

Visualization Style and Data Compatibility

| | Data Format | | | | | | | |
|---|---|---|---|---|---|---|---|---|
| | | | | | Work | | | |
| | Tabular | Tabular | Vector * | Relational | Flow | Equation | Hierarchical | Other |
| | Data Type Pattern | | | | | | | |
| Visualization | | Numeric/ | | | | | | |
| Style | Numeric | Text | Numeric | XML | XML | Equation | XML | XML |
| Column | X | | | | | | | X |
| Bar | X | | | | | | | X |
| Line | X | | | | | | | X |
| Scatter | X | | | | | | | X |
| Radar | X | | | | | | | X |
| Pie | X | | | | | | | X |
| Surface | X | | | | | | | X |
| Tree diagram | | X | | | | | | X |
| Mind Maps | | | | X | | | X | X |
| Flow Chart | | | | | X | | | X |
| Area | X | | | | | | | X |
| Network | | X | | X | | | X | X |
| Relation | | X | | X | | | X | X |
| Visual | | | | | | X | | X |
| Algorithm | | | | | | | | |
| Heat map | | X | | | | | | X |
| Gantt Chart | | | | | | | | X |
| Organizational | | | | X | X | | X | X |
| Chart | | | | | | | | |
| Math Graphs | X | | | | | | | X |
| Tag Cloud | | X | | | | | | X |
| 3D Shapes | X | | | | | | | X |
| Size | X | X | | | | | | X |
| Comparisons | | | | | | | | |
| Vann | | X | | | | | | X |
| Diagrams | | | | | | | | |
| History/ | | | | | X | | | X |
| Timeline | | | | | | | | |
| Music | | X | | | | | | X |
| Molecules | | | | X | | | X | X |
| Brackets | | X | | | | | | X |
| Gauges and | X | | | | | | | X |
| Dials | | | | | | | | |
| Genetic | | X | | | | | | X |
| Graph | | | | | | | | |

The analysis further compares 503 the data information to a look-up table of algorithms 503a. Following is an example of the algorithm look-up table 503a:

Algorithm and Data Compatibility

| | Numeric data (at | Numeric data (at | |
|---|---|---|---|
| | least 1 row or | least 4 rows or | |
| | column) | columns) | Text |
| Moving average | X | | |
| Bollinger Bands | X | | |
| MACD | X | | |
| Stochastic | | X | |
| oscillator | | | |
| Keyword | | | X |
| Extractor | | | |

The analysis engine compares 507 the data type patterns to a set of stored data type patterns 507a. Following is an example of stored data type patterns:

Data Type Patterns

| | | |
|---|---|---|
| Text | Text | Text |

1

| | | | |
|---|---|---|---|
| Date | Numeric | Numeric | Numeric |
| Date | Numeric | Numeric | Numeric |
| Date | Numeric | Numeric | Numeric |
| Date | Numeric | Numeric | Numeric |

2

| | | | |
|---|---|---|---|
| Text | Numeric | Text | Numeric |
| Text | Numeric | Text | Numeric |
| Text | Numeric | Text | Numeric |
| Text | Numeric | Text | Numeric |

3

| | | | |
|---|---|---|---|
| Numeric | Numeric | Numeric | Numeric |
| Numeric | Numeric | Numeric | Numeric |
| Numeric | Numeric | Numeric | Numeric |
| Numeric | Numeric | Numeric | Numeric |
| Numeric | Numeric | Numeric | Numeric |

The analysis engine can additionally rank or sort 504 the results of the visualization style compatibility look-up table 502a and the algorithm compatibility look-up table 503a and stored data type patterns 507a to reflect popularity of styles, uses, preferences, and published information. For example, the results can be sorted based on identification, title, hits, published date, style, mode, developer, and user rating. Additionally, the user can choose how he would like his results sorted. See FIG. 5b for examples of sortable fields. While it is preferable to perform all of the comparisons and intelligently sort the results, only the visual style comparison 502 is necessary. Additionally, the analysis engine can compare visual styles 502 and compare algorithms 503 or compare visual styles 502 and sort the results 504. The appropriate combination will be apparent to someone skilled in the art, and additional comparisons and look-up tables can be added depending on additional features, as will also be apparent to someone skilled in the art. Finally, after the recommendation engine performs the desired comparisons and sorts or ranks the results 505, the suggestions are saved or logged 506. The visualization tool 110 next accesses and executes the transformation interface 180.

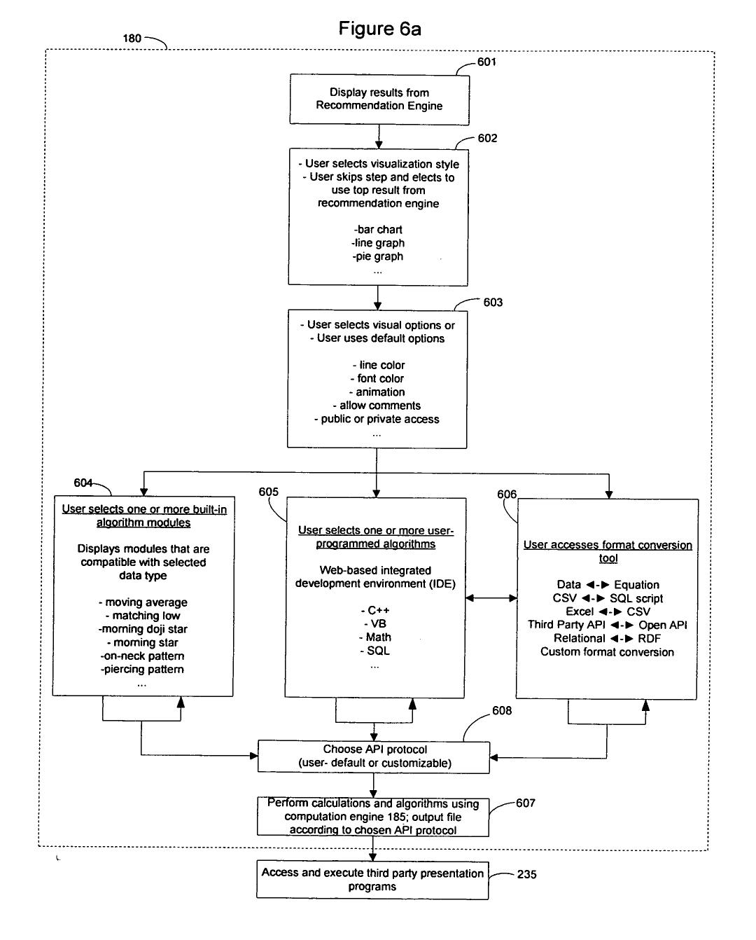

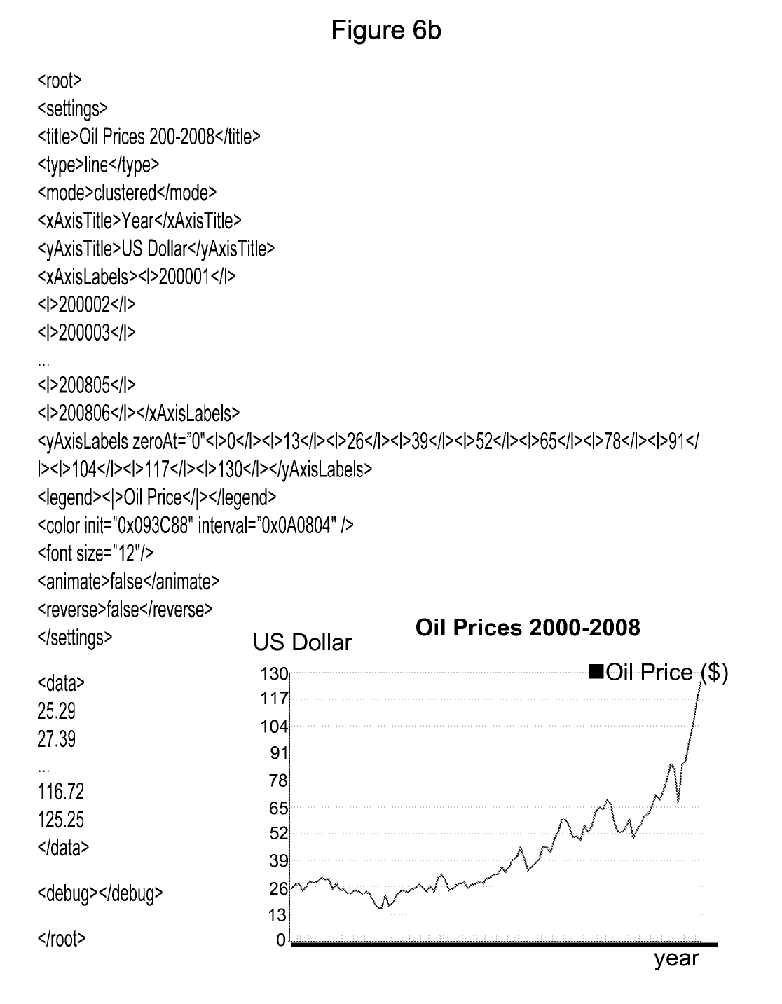

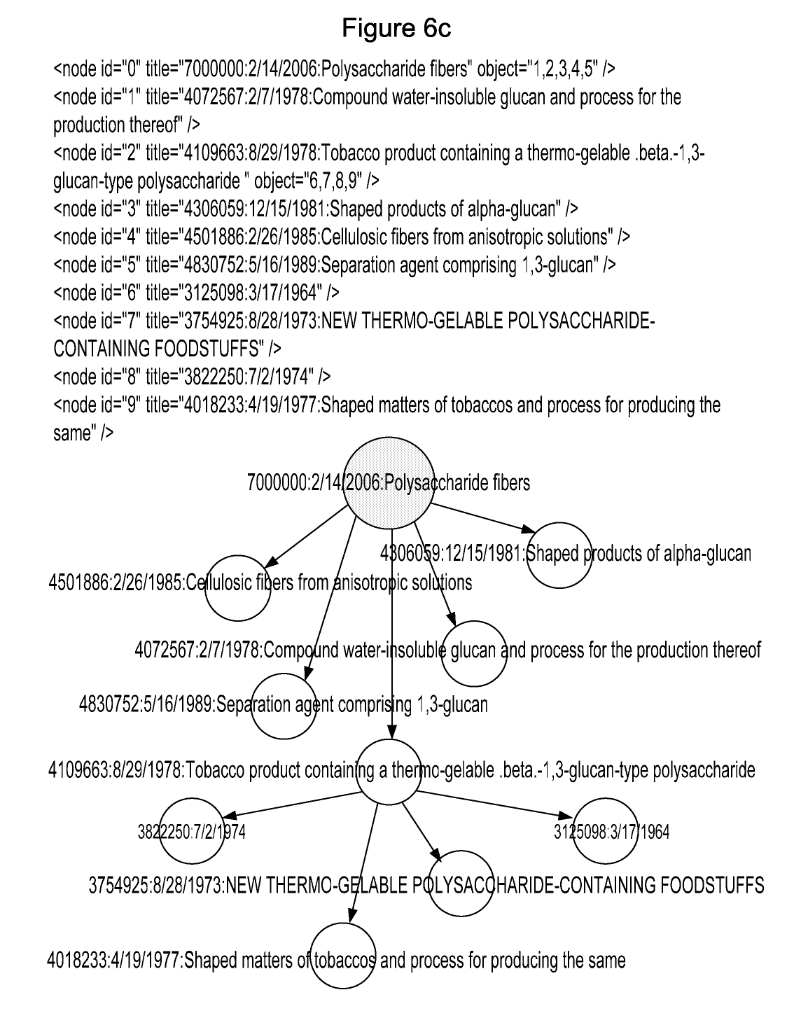

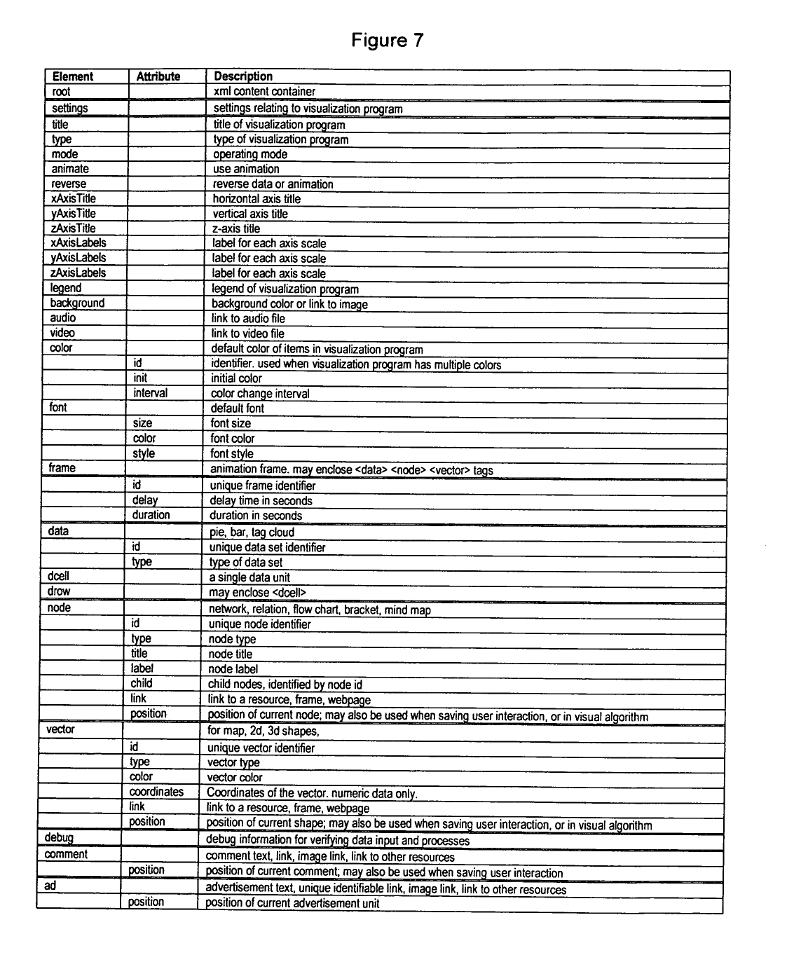

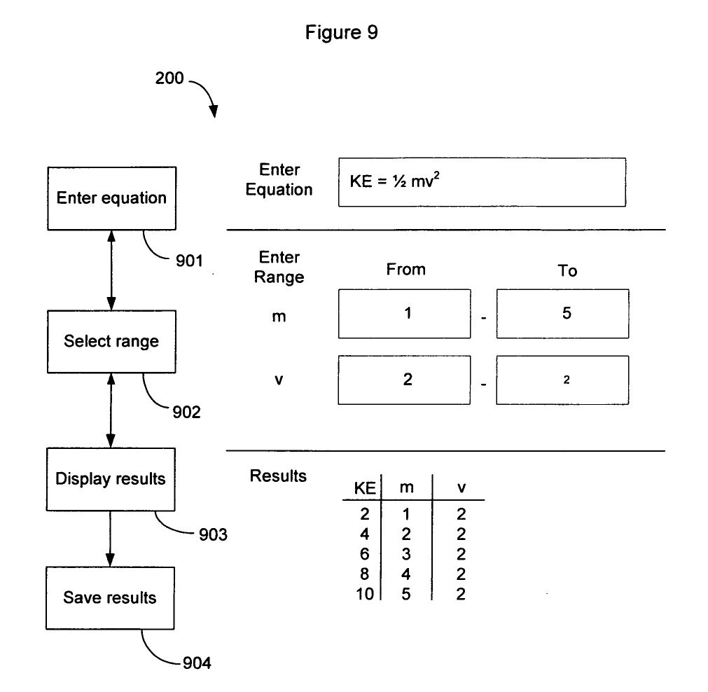

FIG. 6a illustrates the transformation interfaces 180 accessed and executed by the visualization tool 110. In general, the transformation interface 180 includes an interface where a user can select display styles, display options, and, if appropriate, additional built-in or pre-programmed algorithms or user-provided algorithms. The transformation interfaces 180 includes a computation engine 185 that executes any selected algorithms and performs any calculations associated with the chosen visual style and outputs the data as a file according to a given API protocol, such as a visualization API protocol of the computing platform as shown in FIG. 7 or a user-customizable API protocol. In detail, the transformation interface displays 601 the results of the recommendation engine 170. These results indicate suitable visual styles for displaying the target data source, such as bar charts, line graphs, and pie charts for numerical data. The user can select 602 either one or more of the display styles presented or can elect to use the highest ranked style from the recommendation engine 602. The user can also select 603 from several visual options or can elect to use default visual options. For example, the user can choose line colors, font colors, and animations. Additionally, the user can elect whether to allow comments and whether to allow public or only private access. In addition to selecting the visual style and visual options, the user can elect as part of the computation engine 185 to use any built-in or pre-programmed algorithm modules 604, any user-programmed algorithms 605, or access a format conversion tool 606. In particular, the user will be presented with built-in or pre-programmed modules that are compatible with their selected data type. Built-in modules include, for example, moving average, matching low, morning doji star, morning star, on-neck pattern and piercing pattern. Similarly, user-programmed algorithms can be used through a Web-based integrated development environment. The user-programmed algorithms may be, for example, C++, VB, Math, or SQL. Finally, if necessary, a format conversion tool can be accessed to convert between data and equations, CSV and SQL script, Excel and CSV, open API and third-party API, or any custom format conversions. FIG. 9 illustrates a data-equation conversion tool. Also through the transformation interfaces 180, the user elects to use a given API protocol, for example the visualization API protocol or a user-customizable protocol. The user may also use the Web-based integrated development environment to customize protocol output. A particular advantage of the Web-based computing platform 100 is that a user can customize an API protocol rather than having to only use the visualization API protocol associated with the platform 100.

After a user has chosen a built-in or pre-programmed algorithm module or a user-programmed algorithm, the computation engine 185 executes any selected algorithms and performs any calculations associated with the chosen visual style and outputs the data into a file formatted according to the given API protocol 608. If desired, the output file can also include instructions for embedding advertisements when the visual display is later generated. The visualization tool 110 then uses the output of the computation engine 185 with a third party presentation program 235 compatible with the given API protocol. For example, using the given API protocol, designers can build visualization and Flash-based applications to generate visual displays from the output of the computation engine 185. Third-party presentation programs 235 include programs developed by independent programmers and designers as well as any presentation programs that are part of the Web-based computing platform 100 or directly associated with the visualization tool 110. Additionally with respect to the visualization API protocol of the computing platform 100, it is backwards compatible so that its results can also be converted to a protocol design for use with additional third-party presentation programs. The display created by the third-party presentation program 235 can then be displayed 190 by the Web-based computing platform 100 according to the user's preferred display method, stored in a user's account or published to a private or public website, a blog, a mobile device, a gallery or elsewhere. FIG. 6b is an example of the generated API file and resulting presentation for a tabular and numeric data source that the user chose to be displayed as a line chart. FIG. 6c is an example of a generated relational API file and the resulting display.

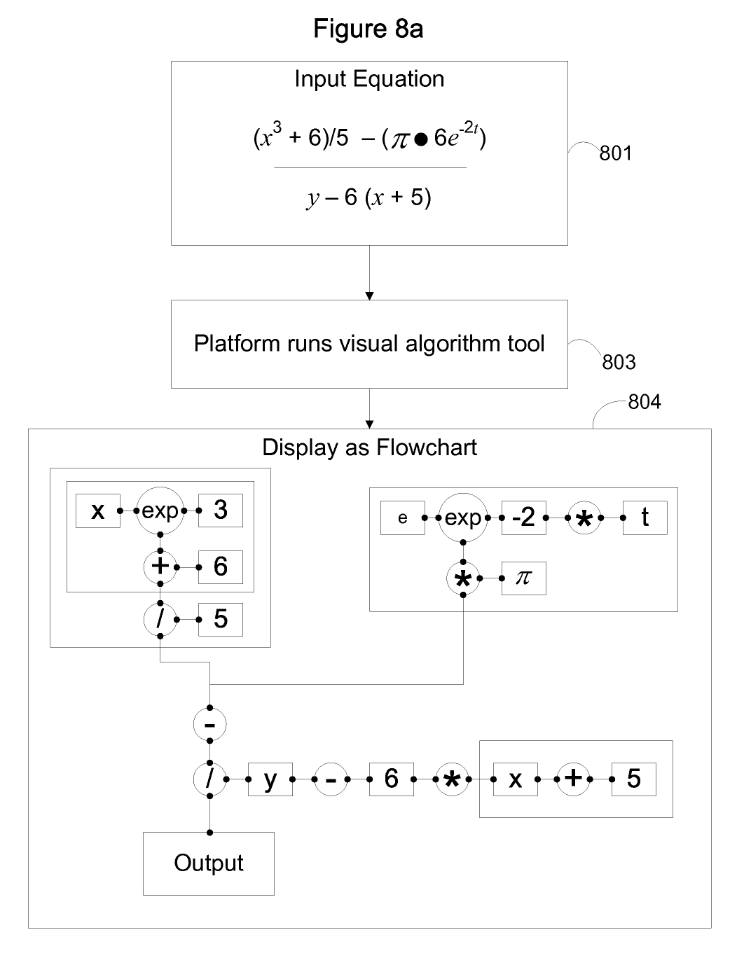

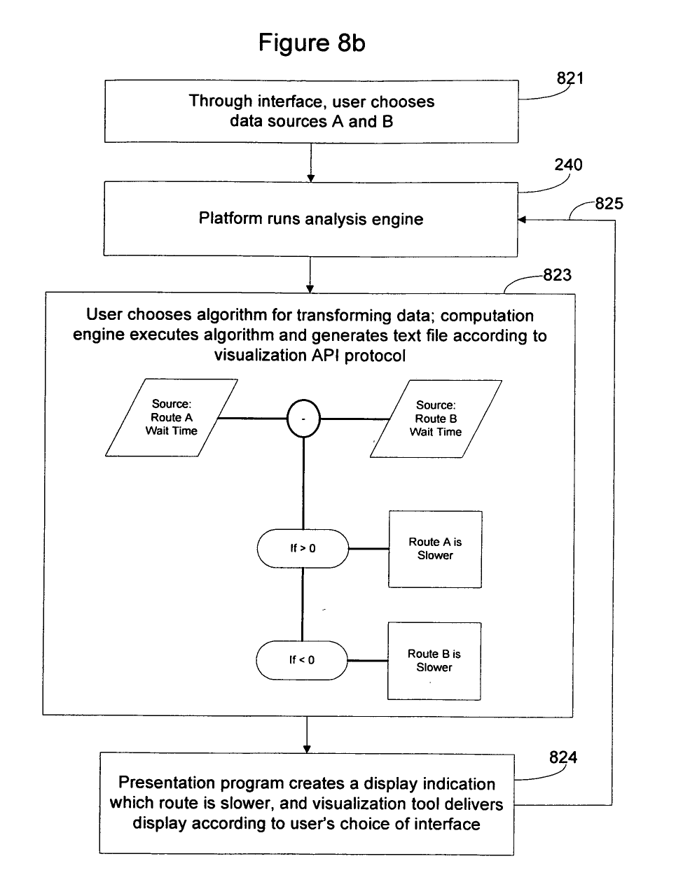

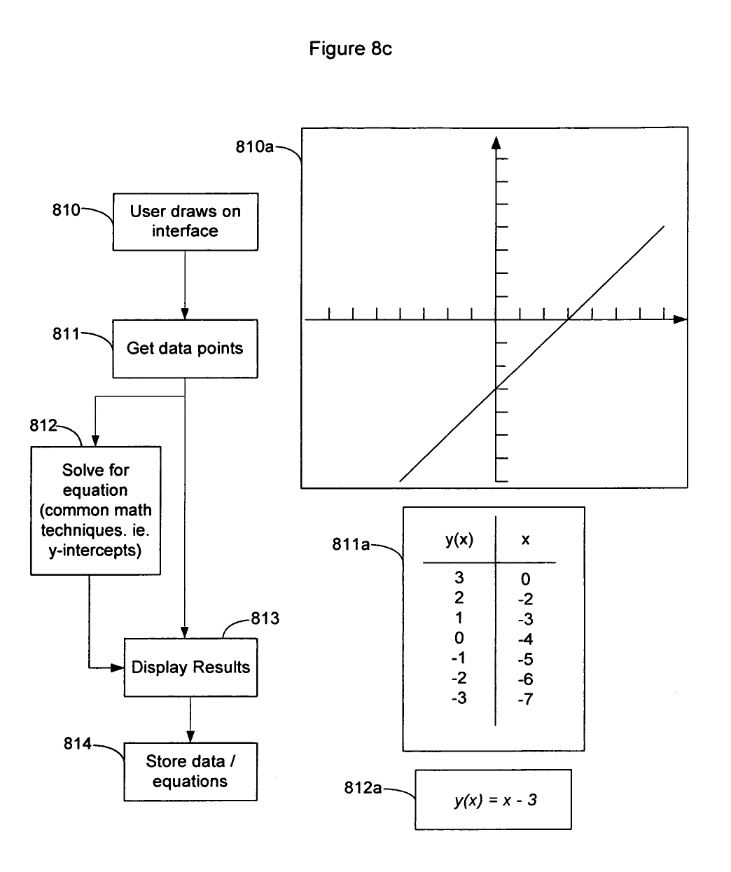

FIG. 8a illustrates one example of the visualization tool 110 as applied to data in the form of an equation. The visualization tool 110 can transform data in the form of equations into a visual algorithm. For this type of visual display, the visualization tool 110 is preferably accessed directly by the website associated with the computing platform. First, the user inputs an equation 801 as the data source and the computing platform accesses and executes 803 the visualization tool. Through the visualization tool, if the user knows he wants to display a flowchart, he can proceed directly to the transformation interface. Otherwise, he can access and execute the recommendation engine 170, which would suggest a flowchart as a suitable display style. Next, the user elects through the transformation interfaces 180 to generate the visual display style of a flowchart. The computation engine 185 then generates an output file according to the visualization API protocol. A third-party presentation 235 program builds a flowchart display 804, which the visualization tool 110 can then display 190 on the user's computer screen. If desired, the solution can also be displayed. Additionally, the equation in a simplified form can be displayed. As with the other visualization options, the process also can be reversed: a flow chart can be supplied by the user and the corresponding equation can be generated.

FIG. 8b illustrates another example of the visualization tool 110 of the computing platform 100 as it is applied to multiple live data sources. In this example, multiple data sources can be analyzed and a custom algorithm can be provided. The user can choose to have the display be a simple message. For example, a user may want to know whether to take Route A to get home from work or Route B to get home from work based on live reports of current traffic conditions. Current traffic conditions are recorded and broadcast by various agencies and news organizations. The user accesses the Web-based computing platform through the website and selects multiple live data sources 821. The visualization tool 110 accesses and executes the analysis engine 240. Then, through the transformation interfaces 180, the user selects either a built-in algorithm module or inputs a user-generated algorithm for comparing the two data sources and determining which one is larger, i.e. a slower route 823. For example, the user elects to use the built-in algorithm Route A-Route B, associates Route A and Route B with a live data source, and then requests the solution to identify the slower route. The computation engine 185 calculates the data and creates an output file according to the visualization API protocol. A third-party presentation program 235 then generates a display 190 saying which route is slower, which is delivered to the user by the visualization tool 110. For example, the message 824 “Route A is slower” displayed if the solution is greater than 0 or the message “Route B is slower” displayed if the solution is less than 0. The visualization tool tracks the live data and the presentation program is executed again when the solution changes 825. As shown by this example, a user can associate a computation with any live data source and can request appropriate messages depending on the solutions. As with the other examples, the user may also input his unique identification code or username, for billing purposes and for recording the session. Additionally, a user may save the computation and personalize his access and use for the platform to always include a display of the equation and its solution.

FIG. 8c illustrates a third example of the visualization tool 110 as applied to data already in the form of a graph. The graphical data can be transformed into an equation and data. First, a user inputs data by drawing a graph on the chosen interface 810. FIG. 8b includes an example of a user-drawn graph 810a. Then the user elects through the transformation interfaces 180 either to run a built-in algorithm module or a user-generated algorithm to ascertain the data points of the graph 811 and calculate the appropriate equation 812. FIG. 8b includes an example of data points 811a and equation 812a corresponding to the user-drawn graph 810a. Solving for the equation, for example, involves using common math techniques such as finding y-intercepts. The result is then displayed as a chart 813 for the user and the equation and data can be stored 814 in the data repository 120.

FIG. 9 illustrates the data and equation generator tool, an additional feature of the transformation interfaces 180 of the Web-based computing platform. Through the tool, a user can input an equation 901 and select a range of input data 902. Through methods known to those skilled in the art, the computing platform then can perform the computation. The results can be displayed 903 and saved 904 to the data repository 120 or used for further calculations by the computation engine or any pre-programmed or user-generated algorithms.

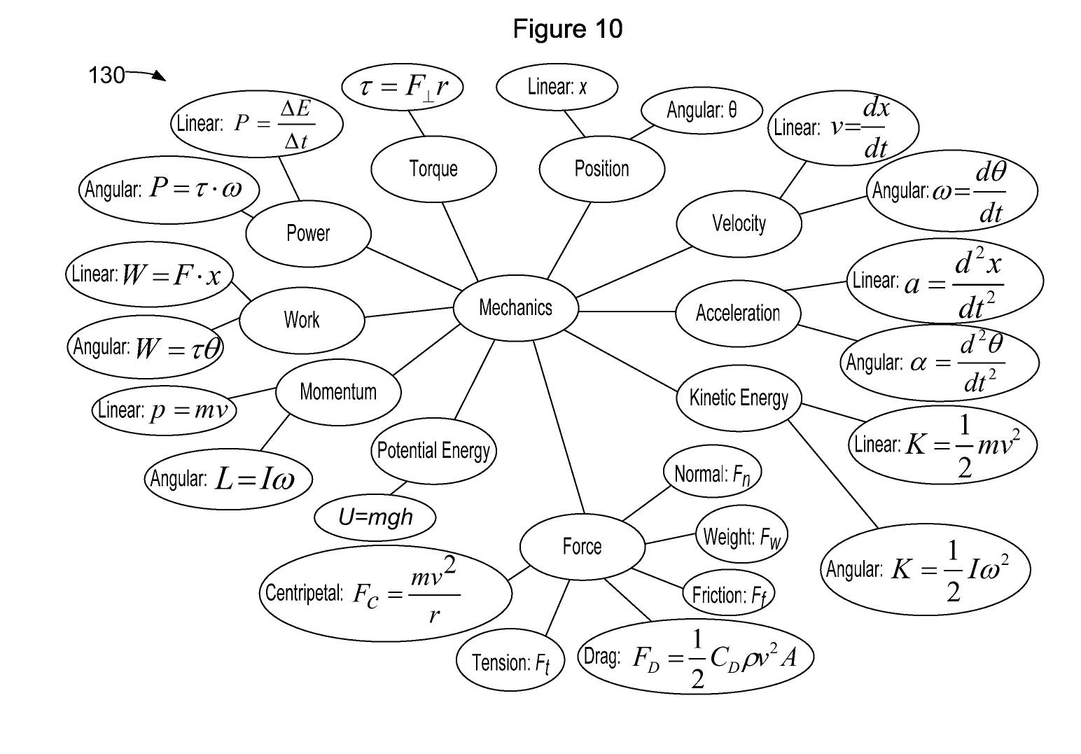

FIG. 10 illustrates another feature of the computing platform accessible by the visualization tool 110, a platform or library 130 for equations, functions, macros, definitions, formulas, comments, ratings and documentation entries in the form of a static page or an editable wiki page. Each entry may contain meta data that describes its relationship to other entries in the library. For example, various equations and their relationships can be stored and mapped for a user's reference. FIG. 10 shows a map of mechanics equations. If a user wanted to see how the linear velocity equation relates to other equations, the platform will present a diagram similar to FIG. 10. A user can simply access the library through the website or Web service associated with the computing platform. The library can include folders with equations. For example one could choose physics.mech.newton1( ) to solve a physics equation regarding mechanics using Newton's 1^{st} law. Another example is math.calculus.deriv( ) or math.deriv( ) to find a derivative. Users can also map a pre-defined function or folder name to a name of their own choosing. Users can create shortcuts and also write and save programs, macros or code snippets for easy access of frequently used functions. These can be written in a variety of programming languages supported by the platform, such as mathematical expressions, C++, and visual basic, as is known in the art. Any of these equations or programs can be accessed by and used in the computation engine 185.

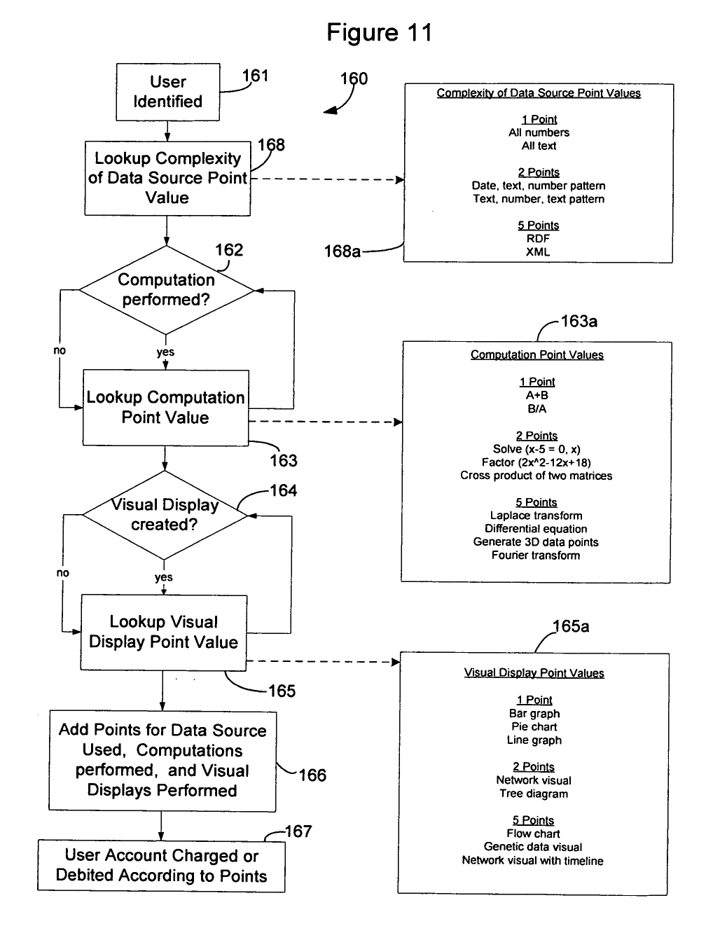

An additional feature of the computing platform and visualization tool is a point-based and complexity-based payment system 160 that accurately reflects the complexity of the visualizations displayed and computations performed. See FIG. 11. As described previously, each user of the visualization tool can be identified in a unique way such as by an email address, phone number, or username. The billing method involves first identifying the user 161. Then the billing method identifies the data source used and looks up a point value related to the complexity of the data source 168 in the data source look-up table 168a. Then the billing method identifies if any computations were performed 162. If they were, the computation point value is determined 163 by accessing a computation look-up table 163a. This process is repeated until a point value is recorded for each computation performed. Next, the billing method identifies if any visual displays were created 164. If they were, the display point value is determined 165 by accessing a display look-up table 165a. This process is also repeated until a point value is recorded to each display created. Then the total points are added together 166 and the user's account is charged according to the sum of the points 167. What choices users make for data sources, computations, and presentations can be monitored and each of the look-up tables can be updated to reflect popularity or choices, availability, and additional features. For example, the point value and accordingly the cost of performing certain visualizations can increase or decrease as demand changes.

According to the payment system 160 illustrated in FIG. 11, each type of visual display is assigned a point value based on the complexity of the display. Similarly, each computation is assigned a point value based on the complexity of the computation. As detailed by computation look-up table 163a and display look-up table 165a, point values are assigned based on the complexity of the computation performed or display created. For example, a simple bar graph is assigned a point value of 1, and a simple addition computation is assigned a point value of 1. A line graph and a computation such as solving for x given the equation x−5=0 are assigned point values of 2. A flow-chart display is assigned a point value of 5, and a computation such as a generating three dimensional data points is assigned a point value of 5. Alternatively, complexity can also be determined from known methods, such as cyclomatic complexity or static analysis. Additional complexity-based look-up tables can be included as well. For example, as shown in FIG. 11, a complexity of data source look-up table 168a can be consulted 168 as well. By assigning point values based on complexity, users pay only for their level of use of the computing platform. This in turn will encourage users to simplify their algorithms and will encourage programmers to write efficient code. As a user generates visual displays and accesses the computation engine, the visualization tool accesses a look-up table of displays and their associated point values and computations and their associated point values to determine the overall points to charge the user. A user can pre-pay his account for a certain number of points or they can be billed or charged for the amount of points they use.

Finally, the computing platform includes a gallery 220 for showcasing visualizations and algorithms and a community for users 140 to collaborate and exchange expertise with others. Collaborative uses of the website include using it as an education center for schools. For example, teachers can use the visualization tool to track students' performance and create visual displays. The platform can also be used for medical uses, such as collecting and tracking data related to a patient's or user's diet or blood pressure. Additional collaborative uses include scientists and engineers sharing their research and results with colleagues around the world, finding people with similar interests who may contribute to research, publishing live results, and accessing other community-members research and results.

Throughout the specification the aim has been to describe the invention without limiting the invention to any one embodiment or specific collection of features. Persons skilled in the relevant art may realize variations from the specific embodiments that will nonetheless fall within the scope of the invention.

I claim:

1. A method executed in a computer system for producing visual displays of data comprising:
a. accessing at least one data source;
b. recommending to a user at least one visual display choice suitable for the data source;
c. recording a user's selection of at least one display choice from visual display choices recommended to the user; and
d. generating a file according to the user's selection and according to a given protocol for use with a presentation program using the given protocol.

2. The method of claim 1 wherein accessing a data source comprises accessing data that has been input by a user.

3. The method of claim 1 wherein accessing a data source comprises accessing a database on the World Wide Web.

4. The method of claim 1 wherein accessing a data source comprises accessing a live source of data.

5. The method of claim 1 wherein accessing a data source comprises accessing data generated by a software program.

6. The method of claim 1 further comprising extracting data from the data source before recommending at least one visual display choice suitable for the data source.

7. The method of claim 6 wherein extracting data comprises identifying data and data format, extracting data and data format, and recording data and data format.

8. The method of claim 1 further comprising mining data from the data source.

9. The method of claim 8 wherein mining data comprises:
a. downloading a first page of data;
b. generating a template;
c. downloading one or more additional pages of data; and
d. parsing data in the additional pages of data using the template.

10. The method of claim 1 wherein the given protocol is a user-customizable protocol.

11. The method of claim 1 wherein generating a file further comprises embedding instructions for advertisements in the file.

12. The method of claim 1 wherein recommending at least one visual display choice comprises:
a. accessing a look-up table of compatible visual display styles;
b. determining a set of one or more visual display styles compatible with the data source,
c. presenting to the user the set of one or more compatible visual display styles.

13. The method of claim 12 wherein recommending at least one visual display choice further comprises:
a. accessing a look-up table of compatible pre-programmed algorithms;
b. determining if any algorithms are compatible with the data source; and
c. if any algorithms are compatible, determining a set of one or more algorithms compatible with the data source and presenting to the user the set of one or more compatible algorithms.

14. The method of claim 12 wherein recommending a visual display further comprises sorting the set of visual display styles.

15. The method of claim 1 wherein generating a file according to a user's selection comprises executing an algorithm associated with the display choice selected by the user.

16. The method of claim 15 wherein executing an algorithm comprises executing a pre-programmed algorithm.

17. The method of claim 15 wherein executing an algorithm comprises executing a user-provided algorithm.

18. The method of claim 1 further comprising accessing a presentation program compatible with the given protocol, providing the file to the presentation program, and executing the presentation program to generate a visual display.

19. The method of claim 18 further comprising delivering the visual display to the user.

20. The method of claim 19 wherein delivering the visual display to the user comprises delivering the visual display to a computer monitor.

21. The method of claim 19 wherein delivering the visual display to the user comprises delivering the visual display to a mobile device.

22. The method of claim 20 further comprising publishing the visual display on a website.

23. The method of claim 1 further comprising charging a fee to a user according to the complexity of the user's selected display choice.

24. The method of claim 23 wherein charging a fee to a user according to the complexity of the user's selected display choice comprises:
a. accessing a look-up table of visual display choices and recording a point value; and
b. calculating a fee based on the point value.

25. The method of claim 1 wherein the data source is a graph and wherein the recommended set of display options comprises displaying an equation corresponding to the graph.

26. The method of claim 1 wherein the data source is an equation and wherein the recommended set of display options comprises displaying the equation as a flowchart.

27. The method of claim 1 wherein accessing at least one data source comprises accessing a first data source and accessing a second data source and wherein the recommended set of display options comprises displaying a comparison of the first and second data sources.

28. A method executed in a computer system for producing visual displays of data comprising:
a. accessing at least one data source;
b. extracting data from the data source;
b. accessing a look-up table of compatible visual display styles;
b. determining a set of one or more visual display styles compatible with the data,
c. presenting to the user the set of one or more compatible visual display styles;
c. recording a user's selection of at least one display choice from visual display choices recommended to the user; and
d. generating a file according to the user's selection and according to a given protocol for use with a presentation program that uses the given protocol.

29. The method of claim 28 further comprising before generating a visual display of the data according the user's selection:
a. accessing a look-up table of compatible pre-programmed algorithms;
b. determining if any algorithms are compatible with the data;
c. if any algorithms are compatible, determining a set of one or more algorithms compatible with the data source and presenting to the user the set of one or more compatible algorithms; and
d. executing an algorithm associated with the user's selection of compatible algorithm.

30. A method executed in a computer system for producing visual displays of data comprising:
a. accessing at least one data source;
b. extracting data from the data source;
c. accessing a look-up table of compatible visual display styles;
d. determining a set of one or more visual display styles compatible with the data,
e. presenting to the user the set of one or more compatible visual display styles;
f. recording a user's selection of at least one display choice from visual display choices recommended to the user;
g. accessing a look-up table of compatible pre-programmed algorithms;
h. determining if any algorithms are compatible with the data;
i. if any algorithms are compatible:
i. determining a set of one or more algorithms compatible with the data source;
ii. presenting to the user the set of one or more compatible algorithms;
iii. recording a user's selection of at least one algorithm; and
iv. executing an algorithm associated with the user's selection of algorithm;
j. generating a file according to the user's selection and according to a given protocol for use with a presentation program compatible with the given protocol.
k. accessing a presentation program compatible with the given protocol, providing the file to the presentation program, and executing the presentation program to generate a visual display; and
l. delivering the visual display to the user.
